(19) United States
(12) Patent Application Publication
(10) Pub. No.: US 2020/0183397 A1
(43) Pub. Date: Jun. 11, 2020

(54) METHOD FOR HANDLING GOODS

(71) Applicant: PREFAB S.R.L., Sasso Marconi (IT)

(72) Inventors: Giovanni ROSSI, Sasso Marconi (IT); Lorenzo ROSSI, Sasso Marconi (IT)

(21) Appl. No.: 16/628,497

(22) PCT Filed: Jul. 6, 2018
(86) PCT No.: PCT/IT2018/050125

§ 371 Date: Jan. 3, 2020

(30) Foreign Application Priority Data
Jul. 7, 2017 (IT) 102017000076968

(51) Int. Cl. G05D 1/02; G01C 21/20; B25J 5/00; B25J 9/16; B25J 19/02

(52) U.S. Cl. CPC G05D 1/024; G01C 21/206; G05D 1/0274; G05D 1/0225; G05D 2201/0216; B25J 9/1692; B25J 9/1664; B25J 19/022; B25J 5/007

(57) ABSTRACT

The method for handling goods involves providing an automated guided vehicle (1), provided with a three-dimensional laser sensor, and carrying out the calibration of said automated guided vehicle (1). The next step involves moving said automated guided vehicle (1) within a workplace where said goods are stored, and collecting data relating to the three-dimensional spatial configuration of said workplace using said three-dimensional laser sensor. Said collected data are then compared with a three-dimensional map of said workplace stored in a storage memory of an internal control unit of said automated guided vehicle (1) and the absolute position of said automated guided vehicle (1) is detected.

### TECHNICAL FIELD

The present invention relates to a method for handling goods, as well as an automated guided vehicle for implementing this method.

### BACKGROUND ART

Automated guided vehicles, generally referred to as AGV, have been known for a long time, being used for the automatic transportation of goods, especially pallets, within the warehouse and production areas of industrial facilities, as well as outside the facilities, between detached warehouse areas.

Indeed, there is the need to use automated guided vehicles to move goods in warehouses and production areas, both when premises are small and when the size of premises is considerable, thus requiring that long distances are covered in order to make the movements.

Automated guided vehicles allow to optimize the transport flows, as well as the workflow, since they do not require human intervention and are able to carry out the work continuously. This type of vehicles also allows to improve workplace safety, since the use of manually guided vehicles such as, for example, forklifts, which may cause accidents resulting in injuries to the workers involved, is avoided.

Various types of automated guided vehicles, differing in the driving technologies employed, are currently known.

Notably, wire-guided vehicles, where an electric wire placed below the surface of the floor of the workplace is used, are known. Along the wire, an electric signal is caused to slide at a predetermined frequency, being capable of being suitably detected by dedicated sensing members mounted on the vehicle.

Such an automated guided vehicle is illustrated in U.S. Pat. No. 5,023,790. Such automated guided vehicle comprises a frame on which a support member is mounted at its top to be moved along a substantially vertical direction using a hydraulic actuation lifting mechanism so as to load and unload goods at appropriate stations of the warehouse. Laterally, the vehicle has a control panel provided with a display for interfacing with the operator, which is associated with a control computer. Below the surface of the floor of the warehouse, a network of guide wires used to drive the vehicle along predetermined routes in the warehouse is installed.

A problem with the above-mentioned type of vehicle is related to the installation of the wire, which requires to make openings on the floor, and to the subsequent modification of the routes, if needed, which also requires to make changes to the floor to insert the wire and is therefore expensive, as well as laborious.

A second type of automated guided vehicles is based on a magnetic driving mechanism, i.e., vehicles are provided with reading sensing members capable of detecting a series of magnetic means arranged below the surface of the floor of the workplace. The magnetic means may be magnetic tapes or strips, or magnetic pads distributed so as to define the routes of vehicles.

If that is the case, the installation of the magnetic means turns out to be less complex than that of the wire, but it is still required to make at least a series of holes in the floor and, to modify the routes, it is necessary to install new magnetic means below of the surface of the floor.

The patent EP 2728516 illustrates a further type of automated guided vehicles which provides a radio frequency control system. More specifically, the patent describes a vehicle provided with an antenna or a transceiver capable of detecting the signals emitted by a series of radio frequency tags distributed along the defined routes. The antenna or transceiver cooperates with a computer comprising a storage memory, where a plurality of data associated with respective radio frequency tags are stored, to allow the comparison of the data collected by the antenna or transceiver with the stored data, thus locating the vehicle. There are also automated guided vehicles involving the use of a laser sensor mounted on the vehicle which uses as reference a series of reflectors distributed along the route. Basically, the laser sensor continuously emits a laser beam so as to cover the surrounding region all the time; when the laser sensor detects the reflected radiations from at least three reflectors, a control unit, provided with a special calculation program, can determine the position of the vehicle. In this case, the changes to be made at the workplace are less invasive, but it is still necessary to install new reflectors and modify the program, if the routes have to be modified.

An example of automated guided vehicles using spatial reference objects for navigation is also illustrated in the application WO 2012/173497. Notably, the application describes a system for sharing a map of the workplace among industrial vehicles, especially among automated guided vehicles, which involves the installation of spatial reference objects at the workplace, such as, for example, light sources. Each vehicle of the system is provided with a series of sensors capable of detecting different types of information about the workplace and transmitting them to a computer placed on board the vehicle arranged to extract from such information data relating to the characteristics of the premises so as to draw a local map of the premises surrounding the vehicle. Information about the premises surrounding each vehicle is transmitted to a central computer, in which a global map of the premises is stored.

### DISCLOSURE

The object of the present invention is to address the above-mentioned problems by working out a method allowing to perform optimally the automated handling of goods without the need to make changes to the workplace where they are stored.

Within the scope of this aim, it is a further object of the present invention to provide a method allowing the optimization of the time needed for calibrating the automated guided vehicle used for the implementation of the method.

It is a further object to work out a method for handling goods allowing an easy modification of the predetermined routes for moving goods in the workplace.

It is a further object to work out a method allowing to perform optimally the picking and the depositing of the goods or the support means on which the goods are distributed, such as, for example, the pallets.

It is a further object of the invention to provide an automated guided vehicle of simple constructional and functional conception, absolutely reliable in functioning, versatile in use and relatively cheap.

The above-mentioned objects are achieved, according to the present invention, by the method for handling goods, by the automated guided vehicle and by a system for handling goods according to claims 1, 8, and 10.

The method for handling goods involves providing at least one automated guided vehicle provided with at least a three-dimensional laser sensor and then calibrating said automated guided vehicle in order to obtain a global three-dimensional map of a workplace where said goods are stored.

Preferably, the step of calibrating said automated guided vehicle comprises the step of moving said vehicle in said workplace so as to explore said workplace using said at least one three-dimensional laser sensor and collecting the data relating to the three-dimensional spatial configuration of said workplace using said three-dimensional laser sensor. Finally, the step of calibrating said vehicle comprises the step of processing said data by means of an internal control unit of said vehicle and obtaining, using a calculation program executed by a processor of said internal control unit, said three-dimensional map of said workplace.

Advantageously, the method involves storing said three-dimensional map in a storage memory of said internal control unit and transmitting, through a wireless transmission system, said map to a central control unit, external to said automated guided vehicle. It should be underlined that, when a plurality of vehicles is exploited, it is sufficient to obtain said three-dimensional map with a single vehicle and transmit the map to the central control unit to make it available to the other vehicles. Operational times are thereby optimized.

The method also involves moving said automated guided vehicle within said workplace, and collecting data relating to the three-dimensional spatial configuration of said workplace using said three-dimensional laser sensor.

The next step involves comparing said collected data with said three-dimensional map of said workplace and then detecting the absolute position of said vehicle.

Preferably, the method involves sending data relating to the position of said vehicle to said central control unit through said wireless transmission system.

The method then involves sending to actuating means capable of actuating said vehicle a control signal to direct said vehicle along a predetermined route towards an operating station.

Preferably, at said operating station, the method involves collecting, using said at least one three-dimensional laser sensor, data relating to the size, shape and position of said goods or of the support means on which said goods are distributed, such as, for example, pallets, so as to carry out optimally the picking and/or depositing operations. Finally, the method involves carrying out the picking and/or depositing of said goods or said support means intended for said goods at said operating station.

Preferably, the method involves repeating said step of calibrating said vehicle if it is necessary to modify said workplace or to use a new workplace for storing said goods.

In the event that it is necessary to update the routes or introduce new routes to be followed by said at least one automated guided vehicle, the method advantageously involves updating at least one route stored in said central control unit of said at least one vehicle and/or storing at least one new route in said central control unit.

Preferably, the method then involves transmitting, through said wireless transmission system, data relating to said modified route and/or said new route to said internal control unit of said at least one automated guided vehicle. It should be noted that it is thus not necessary to modify the workplace by installing reference objects, which results in saved time and costs.

Preferably, the method also involves constantly monitoring the charge level of an electric battery of said automated guided vehicle and sending to said actuating means, using said internal control unit, a control signal for directing said automated guided vehicle to an electric charging station for said battery, set up in said workplace, if the charge level of said battery falls below a predetermined threshold value.

The automated guided vehicle which allows to implement the described method comprises a frame; a gripping member, capable of picking said goods, housed in said frame; actuating means associated with said frame for actuating said vehicle; at least one three-dimensional laser sensor associated externally with said frame, capable of collecting data relating to the three-dimensional spatial configuration of the workplace where said goods are stored; an internal control unit, arranged within said frame, comprising a storage memory, said internal control unit being configured to compare said data collected by said at least one three-dimensional laser sensor with a three-dimensional map of said workplace stored in said storage memory in order to detect the absolute position of said vehicle, and being configured to send to said actuating means a control signal for directing said vehicle according to a predetermined route; a wireless data transmission system comprising a data transmission board installed on said vehicle.

The three-dimensional laser sensor is rotated by an actuating member, around a first rotation axis and, at the same time, around a second rotation axis orthogonal to the first rotation axis. It is observed that the combination of the simultaneous rotation of the sensor around the axes together with the data collection speed of the sensor allow to collect a large number of data relating to the workplace. Preferably, said three-dimensional laser sensor is rotatable around each of said rotation axes by an angle which is substantially equal to 360°. A spatial scanning field corresponding to the 360° workplace is thereby obtained.

Preferably, said three-dimensional laser sensor is mounted on a portion opposite to a base of said frame, which substantially corresponds to the top of said vehicle.

Preferably, said vehicle comprises a series of proximity sensors, associated with the front and the rear of said frame, capable of detecting the presence of obstacles and/or people in said workplace.

Preferably, said internal control unit comprises a programmable logic controller or a PC. Alternatively, said internal control unit is implemented by a dedicated electronic board.

Preferably, said internal control unit comprises a first interface for the operator which provides a touchscreen control display and/or a plurality of control buttons.

Preferably, said internal control unit of said vehicle is configured to perform a periodic check, during the predetermined route, of the position of said vehicle by comparing the actual position detected by said three-dimensional laser sensor and the expected position. In the event that the actual position detected is different from the expected position, the internal control unit sends a control signal to said actuating means for aligning the actual position with the expected position.

The present invention also relates to a system for handling goods comprising at least one automated guided vehicle described above and a central control unit, external to said vehicle, configured to receive from said internal control unit of said automated guided vehicle, through said wireless transmission system, data relating to said absolute position of said vehicle and to make sure that said vehicle follows said predetermined route to reach an operating station for the picking and/or depositing of said goods.

Preferably, the central control unit is also configured to ensure the proper operation of the at least one automated guided vehicle, notifying, for example, whether any malfunction occurs.

According to an aspect of the invention, the central control unit is configured to handle a plurality of automated guided vehicles.

### DESCRIPTION OF DRAWINGS

The details of the invention will become more evident from the detailed description of a preferred embodiment of the automated guided vehicle for handling goods according to the invention, illustrated by way of example in the accompanying drawings, wherein:

FIG. 1 shows a schematic plan view of a workplace where the goods are palletized and stored, in which a series of routes for automated guided vehicle and several operating stations are represented;

FIG. 2 is a side view of an automated guided vehicle according to the present invention;

FIG. 3 shows a front view of the automated guided vehicle;

FIG. 4 shows a schematic view of a three-dimensional laser sensor capable of being associated with the automated guided vehicle;

FIGS. 5, 6 and 7 show respective views from different angles of the workplace in which the automated guided vehicles operate, obtained by the three-dimensional laser sensor.

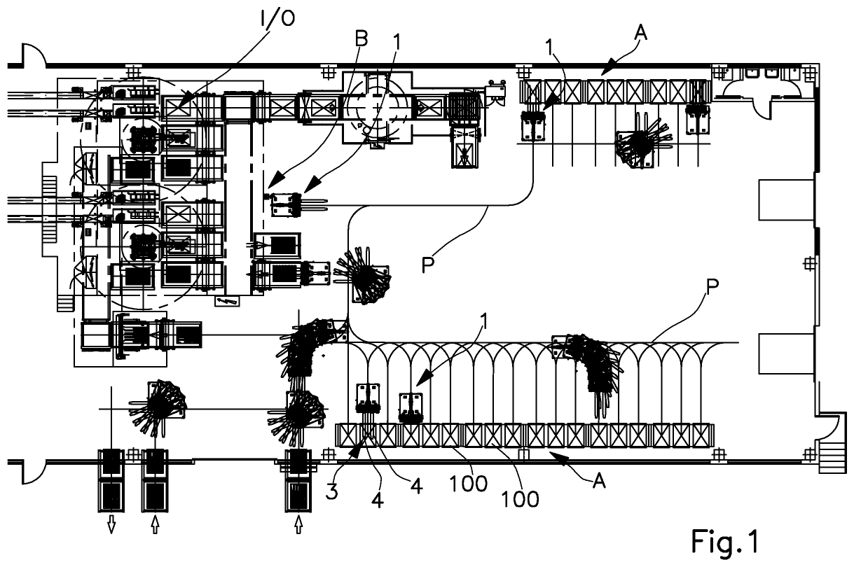

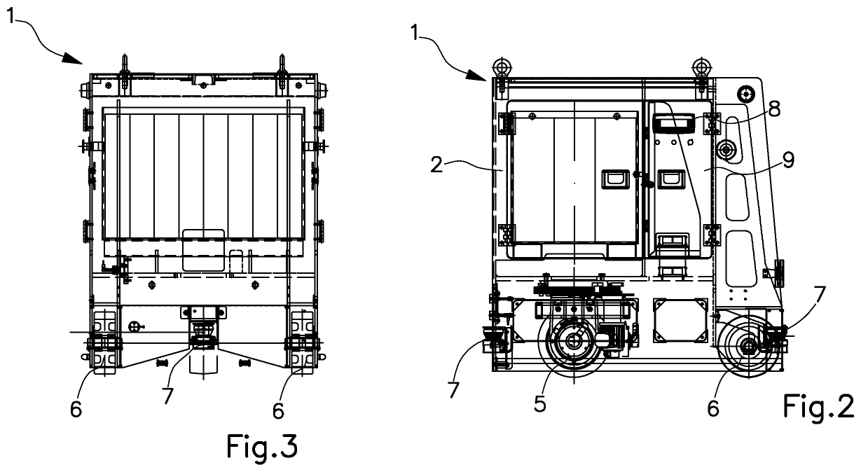

### BEST MODE

With particular reference to these figures, the automated guided vehicle for handling goods according to the present invention is referred as a whole by reference numeral 1. The automated guided vehicle 1 will be indicated by the term vehicle, for simplicity.

The vehicle 1 is suitable for use in workplaces for the production, storage and logistics of goods, such as, by way of example, the production areas, the warehouses of the facilities, the sheds or the external premises of the facilities, in spaces used for these functions.

In these workplaces, specific spaces for storing the goods, which are distributed, for example, on a plurality of pallets 100, are generally provided. More specifically, it is possible to provide a series of operating stations such as at least one entry and/or exit station I/O of the goods, at which the goods are automatically made available on a series of pallets 100.

The pallets 100 are designed to be transported to special storage stations A which are suitably distributed in the workplace. Based on the spatial organization of the operating stations, pre-defined routes P that vehicles 1 must follow for the movement of the goods are developed.

It is also possible to arrange at least one station B for the electric charging of vehicles 1, as will be specified below.

The vehicle 1 comprises a frame 2 in which a gripping member 3 capable of picking the goods is housed.

The gripping member 3 is suitably shaped to grasp optimally the type of product for which it is intended, therefore the shape of the gripping member 3 varies according to the characteristics of the product.

According to the embodiment shown in the figures, the gripping member 3 is carried by the frame 2 at its front and comprises, in a manner known per se, a sort of fork formed by a pair of elongated elements 4 which extend over a substantially horizontal plane and define the goods support plane.

The gripping member 3 is movable along a first substantially vertical direction.

More specifically, the gripping member 3 is associated with a plate that slides, upon actuation of a lifting mechanism, on appropriate guides which extend along the first substantially vertical direction. The lifting mechanism is of known type and therefore not further described.

It is possible to allow the gripping member 3 to move along a second direction, substantially orthogonal to the first direction, allowing a bidirectional movement of the goods loaded onto the support surface.

The vehicle 1 comprises movement means capable of being actuated by suitable actuating means 5 for moving the vehicle 1 itself. The movement means comprise, for example, a series of wheels 6 on which the frame 2 is mounted.

The actuating means 5 are associated with the frame 2 and are preferably constituted by at least one driving member, capable of actuating the rotation of the wheels 6.

The driving member is powered by an electric power supply such as a rechargeable battery, not visible in figures. When the rechargeable battery reaches an insufficient charge level, it is properly recharged at the charging stations B set up in the workplace, thus guaranteeing the continuous operation of the vehicle 1.

The vehicle 1 is provided with a series of proximity sensors 7, associated with the front and the rear of the frame 2, capable of detecting the presence of obstacles and/or people in order to avoid collision.

The proximity sensors 7 comprise at least one laser sensor capable of emitting a laser beam and detecting any beam reflected by the obstacle and/or the person.

Alternatively, proximity sensors can be infra-red sensors. According to the present invention, the vehicle 1 is provided with at least a three-dimensional laser sensor 10 capable of collecting the data relating to the three-dimensional spatial configuration of the workplace.

The three-dimensional laser sensor 10 is associated externally with the frame 2.

Preferably, the three-dimensional laser sensor 10 is mounted on a portion opposed to a base of the frame 2, which substantially corresponds to the top of the vehicle 1.

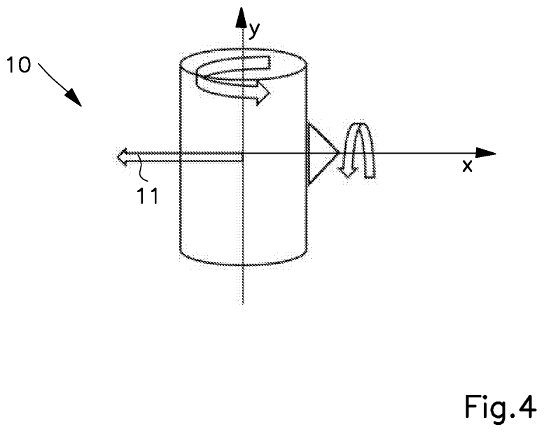

The three-dimensional laser sensor 10 is adapted to rotate around a pair of mutually orthogonal rotation axes, indicated by the references x and y in FIG. 4, to continuously detect the three-dimensional data relating to the workplace.

The three-dimensional laser sensor rotates around each rotation axis x, y by an angle which is substantially equal to 360°.

The rotation of the three-dimensional laser sensor 100 is actuated by an actuating member, not shown, around the first rotation axis x and, simultaneously, around the second orthogonal rotation axis y. In this way, the laser beam 11 of the sensor 10 defines, by rotating around the y axis, a detection plane which is rotated about the x axis due to the rotation of the sensor 10 around this axis. The combination of the simultaneous rotation of the sensor around the axes x, y together with the data collection speed of the sensor allow to collect a large number of data relating to the workplace.

The rotation of the sensor 10 around the two x, y axes of an angle having an amplitude substantially equal to 360° allows to obtain a spatial scanning field corresponding to the 360° workplace.

In this way, a three-dimensional scan of the workplace is performed, i.e. the objects in the environment are identified and defined according to the three spatial coordinates x, y and z.

By way of example, the number of data detected by the sensor 10 is in the order of millions of data per second.

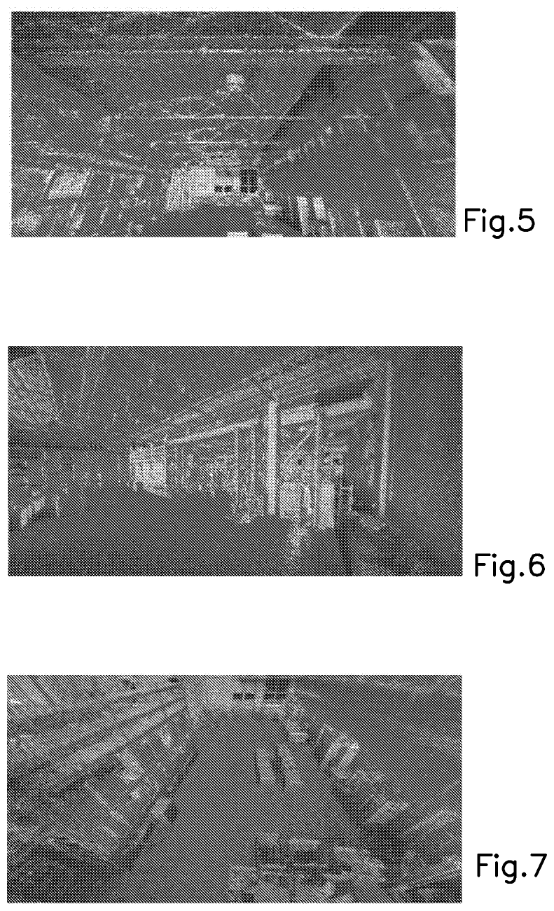

Some examples of images of the workplace collected by the three-dimensional laser sensor are shown in FIGS. 5, 6 and 7.

As can be seen from the above figures, it has been experimentally observed that the three-dimensional laser sensor 10 allows a detailed reconstruction of the premises to be performed.

More in detail, the three-dimensional laser sensor 10 collects data relating to the dimensional and shape characteristics of the objects within the premises in order to obtain a three-dimensional map of the premises.

It should be noted that the sensor's characteristic of collecting data relating to the dimensional and shape characteristics of the objects is advantageous as it also allows to collect information on the dimensions and shape of the goods and the pallets 100, as shown in FIG. 7. In this way it is possible to easily pick and/or deposit the individual goods from/on the pallets 100 since their picking and depositing positions and their dimensions are known. It is also possible to detect any obstacles on the vehicle route, and thus avoid them or to stop the vehicle.

The data is sent by the three-dimensional laser sensor 10 to an internal control unit, arranged inside the frame 2.

The internal control unit is preferably a programmable logic controller (PLC).

Alternatively, the internal control unit can be a PC or a dedicated electronic board.

The internal control unit comprises a first interface for the operator which provides a touchscreen control display 8 and/or a plurality of control buttons.

The internal control unit is easily accessible through a door 9 made on the frame 2.

This control unit comprises a processor for processing data, for example data acquired from the sensors, and a storage memory.

The internal control unit is configured to compare the data acquired by the three-dimensional laser sensor 10 with a global three-dimensional map of the workplace stored in the storage memory so as to detect the absolute position taken by the vehicle 1 and send to the driving member a control signal for directing the vehicle along a predetermined route.

The expression “global three-dimensional map” of the workplace means a map of the entire workplace in which the vehicle 1 operates.

The internal control unit performs a periodic check, during the pre-established route, of the position of the vehicle 1 by comparing the actual position detected through the three-dimensional laser sensor 10 and the theoretical position. In the case where the actual detected position is different from the expected position, the internal control unit sends a control signal to the actuating means to align the actual position with the expected position.

The internal control unit is associated to a calculation program, executable by the processor, capable of deriving, from the data acquired by the three-dimensional laser sensor 10, the aforementioned global three-dimensional map of the workplace. The internal control unit transmits the data acquired from the sensors, including the data relative to the absolute position of the vehicle, to a central control unit, external to the vehicle 1.

Data transmission is performed by a wireless data transmission system, which comprises a data transmission board, installed on the vehicle 1 and not visible in the figures. The data transmission board is preferably Bluetooth or Wi-Fi.

The central control unit is arranged for the management of at least one vehicle 1 in order to verify that the vehicle correctly covers the pre-established route to reach the operating station where the same vehicle 1 is required.

The central control unit is configured to also ensure correct operation of the at least one vehicle 1, signaling, for example, the possible presence of malfunctions.

Preferably, the central control unit is configured to manage a plurality of vehicles 1.

Basically, the central control unit has the task of managing the traffic of vehicles 1 and, if it is necessary to make changes to the routes to be followed, based on picking and/or depositing needs, the control unit updates the previously stored routes and communicates these changes through the wireless transmission system to the internal control unit of the vehicles 1 involved.

The planned routes are appropriately stored both in the internal control unit of each vehicle 1 and in the central control unit.

The central control unit is provided with a second operating interface which comprises a touchscreen control display and/or a plurality of control buttons to allow management by an operator.

It is possible that the central control unit communicates with a workplace management system to acquire the information necessary for the proper management of the circulation of the vehicles 1, such as, for example, information concerning the place where the goods are to be arranged arriving at an entry station.

It is possible that a series of central control units dedicated to the management of vehicles 1 are set up.

The present invention also relates to a method for handling goods which first of all involves arranging the automated guided vehicle 1 provided with the three-dimensional laser sensor 10.

Initially, the method involves carrying out a calibration of the vehicle 1 which consists in processing the global three-dimensional map of the premises.

In particular, this calibration phase involves moving the vehicle 1 in the workplace so as to explore the entire environment by means of the three-dimensional laser sensor 10.

Data on the spatial configuration of the workplace are then acquired using the three-dimensional laser sensor 10.

The next phase involves processing the data by means of the internal control unit and obtaining a global three-dimensional map of the workplace using the calculation program performed by the processor of the internal control unit.

The map is then stored in the storage memory of the internal control unit.

It should be noted that the three-dimensional map is conveniently transmitted through the wireless transmission system to the central control unit.

Once the three-dimensional map has been obtained, the vehicle 1 is again moved in the workplace in which the goods are stored and data relating to the three-dimensional spatial configuration of the premises are collected using the three-dimensional laser sensor 10.

The method then involves comparing the data acquired by the sensor 10 with the global three-dimensional map and thus detecting the absolute position of the vehicle 1.

The method also involves sending to the central control unit, through the wireless transmission system, data collected by the sensors, especially those data relating to the position of the vehicle 1.

Next, a control signal is sent to the actuating means of the vehicle 1 to direct the vehicle 1 along the predetermined route towards an operating station which may be a storage station A or an entry and/or exit station I/O for goods.

At the operating station, the data on the dimensions, shape and position of the pallets 100 and of the individual goods loaded on the pallets 100 are collected using the three-dimensional laser sensor 10 so as to optimally perform the depositing and/or picking operations.

Finally, the method involves depositing and/or picking goods at the operating station. The depositing and/or picking of goods is carried out using the gripping member 3 of the vehicle 1.

It should be noted that picking the individual goods from the pallets 100 and depositing the goods on the pallets 100 are operations made easier by the fact that the actual dimensions of the goods are known thanks to the sensor 10.

To perform a depositing and/or picking operation of the goods, the vehicle 1 is actuated and the previous steps are repeated.

The method also involves constantly monitoring the charge level of the electric battery of the vehicle 1 and, if the battery level of the vehicle 1 falls below a predetermined threshold value, a control signal is sent to the actuating means to direct the vehicle 1 towards an electric battery charging station B set up in the workplace.

If the workplace is modified, for example an extension is made, or if a new workplace is selected, the calibration phase of the vehicle 1 is repeated to obtain an updated or new three-dimensional map of the premises.

If, on the other hand, it is necessary to make changes to at least one route in the same workplace or to add at least one new route, the route stored in the central control unit is updated and/or the new route is introduced in the central control unit. Then, data relating to the modified route or the new route are sent through the wireless transmission system to the internal control unit of the vehicle 1.

The method for handling goods achieves the purpose of automatically moving goods without having to make changes to the workplace in which they are stored.

It is not necessary to install reference objects such as reflectors or the like for the continuous detection of the vehicle position as a three-dimensional map of the environment is obtained by means of the three-dimensional laser sensor and a comparison is made between the data collected by the laser sensor during the movement of the vehicle and the map to determine the absolute position of the vehicle.

A relevant aspect is that the three-dimensional reconstruction of the premises does not take place with the help of reference objects specially installed in the premises or natural reference objects already present in the premises such as columns, beams or similar but it is sufficient to use the three-dimensional laser sensor according to the present invention. The three-dimensional laser sensor, in fact, thanks to the continuous rotation around the axes of rotation orthogonal to each other as well as to the speed of data collection, allows to collect a large number of data related to the workplace from which it is possible to reconstruct three-dimensionally the premises in a detailed way.

Moreover, the rotation of the sensor by a 360° amplitude angle around the rotation axes also describes a spatial scanning field corresponding to the 360° workplace.

It is important to underline that, to make changes to the routes or to prepare new routes that the vehicles must follow, it is sufficient to memorize the modified and/or new routes in the central control unit which will transmit the data relating to these routes to the respective internal control units, therefore, likewise, it is not necessary to modify the environment by installing reference objects, thus saving time and reducing costs.

A particularly advantageous aspect is the fact that the times for the calibration of the vehicle are optimized since it is simply required to move the vehicle in the entire workplace in order to collect the data necessary to obtain a global three-dimensional map. It should also be emphasized that, in the case of use of a plurality of vehicles, it is sufficient to obtain the three-dimensional map with a single vehicle and then to store said map in the central control unit to make it available to the involved vehicles.

Another advantageous aspect is that if the premises are modified or if adding new workplaces is desired, it is sufficient to update the global three-dimensional map by performing vehicle calibration again, thus no complex or expensive operations are required.

The method also achieves the aim of optimizing the picking and depositing of goods or of the support means on which the goods are distributed, such as, for example, pallets. The three-dimensional laser sensor is in fact capable of collecting data relating to the size, shape and position of the pallets and goods allowing to easily pick individual goods from pallets or deposit them on pallets, as well as carrying out the picking and depositing of pallets themselves.

Finally, it should be emphasized that the vehicle is versatile as it can be used both outside the facilities and inside them.

The vehicle disclosed by a way of example is susceptible of several modifications and variations depending on the different requirements.

In the practical embodiment of the invention, the materials used, as well as shape and dimensions, may be any according to requirements.

Where the technical features mentioned in any of the claims are followed by reference numerals, these reference numerals are included to improve the comprehension of the claims only, and consequently they have no limiting effect on the object of each element identified by way of example by these reference numerals.

1. A method for handling goods, the method comprising the following steps:
providing at least one automated guided vehicle provided with at least one three-dimensional laser sensor;
calibrating said automated guided vehicle to obtain a global three-dimensional map of a workplace where said goods arc stored;
moving said automated guided vehicle within said workplace and collecting data relating to a three-dimensional spatial configuration of said workplace via said at least one three-dimensional laser sensor to provide collected data;
comparing said collected data with said global three-dimensional map of said workplace;
detecting an absolute position of said automated guided vehicle;
sending to an actuating means, for actuating said automated guided vehicle, a control signal for directing said automated guided vehicle along a predetermined route towards an operating station;
carrying out depositing and or picking of said goods or a support means on which said goods arc distributed at said operating station.

2. A method according to claim 1, further comprising a further step between the step of sending said control signal to said actuating means carrying out depositing and/or picking of said goods or said support means on which said goods arc distributed at said operating station, the further step comprising:
collecting data relating to a size, shape and position of said goods or said support means via said at least one three-dimensional laser sensor to carry out optimal depositing and or picking operations.

3. A method according to claim 1, wherein said step of calibrating said automated guided vehicle comprises the steps of:
moving said automated guided vehicle within said workplace to explore said workplace via said at least one three-dimensional laser sensor;
collecting data relating to said three-dimensional spatial configuration of said workplace via said at least one three-dimensional laser sensor;
processing said data by an internal control unit of said automated guided vehicle and obtaining said global three-dimensional map of said workplace via a calculation program executed by a processor of said internal control unit.

4. A method according to claim 3, further comprising a plurality of further steps between calibrating said automated guided vehicle and of moving said automated guided vehicle within said workplace and collecting data relating to said three-dimensional spatial configuration of said workplace via said at least one three-dimensional laser sensor, said plurality of further steps comprising:
storing said three-dimensional map in a storage memory of said internal control unit;
transmitting said three-dimensional map to at least one central control unit via a wireless transmission system, said at least one central control unit being external to said automated guided vehicle.

5. A method according to claim 3, further comprising the step of:
repeating calibrating said automated guided vehicle to obtain said global three-dimensional map of said workplace where said goods arc stored in order to obtain an updated or new three-dimensional map of said workplace, if said workplace is to be modified or use a new workplace for storing said goods.

6. A method according to claim 4, further comprising the steps of:
updating at least one route stored in said at least one central control unit and or storing at least one new route in said at least one central control unit;
sending said data relating to said modified route and/or said new route to said internal control unit of said automated guided vehicle via said wireless transmission system.

7. A method according to claim 3, further comprising the steps of:
constantly monitoring a charge level of an electric battery of said automated guided vehicle;
sending a control signal to said actuating means via said internal control unit for directing said automated guided vehicle to an electric charging station for said battery, set up in said workplace, if said charge level of said battery falls below a predetermined threshold value.

8. An automated guided vehicle for handling goods, the automated guided vehicle comprising:
a frame;
a gripping member configured for picking said goods, said gripping member being carried by said frame;
an actuating means associated with said frame for actuating said vehicle;
at least one three-dimensional laser sensor associated externally with said frame, said at least one three-dimensional laser sensor being configured for collecting data relating to a three-dimensional spatial configuration of a workplace where said goods are stored, said three-dimensional laser sensor being actuatable in rotation by an actuator member around a first rotation axis and, at a same time, around a second rotation axis orthogonal to said first rotation axis;
an internal control unit arranged within said frame, said internal control unit comprising a storage memory, said internal control unit being configured to compare said data collected by said at least one three-dimensional laser sensor with a three-dimensional map of said workplace stored in said storage memory in order to detect an absolute position of said vehicle, and said internal control unit being further configured to send a control signal to said actuating means for directing said vehicle according to a predetermined route;
a wireless data transmission system comprising a data transmission board installed on said vehicle.

9. A vehicle according to claim 8, wherein said at least one three-dimensional laser sensor is rotatable around each of said first rotation axis and said second rotation axis by an angle which is substantially equal to 360°.

10. A system for handling goods, the system comprising;
at least one automated guided vehicle comprising a frame;
a gripping member configured for picking said goods, said gripping member being carried by said frame;
an actuating means associated with said frame for actuating said vehicle;
at least one three-dimensional laser sensor associated externally with said frame, said at least one three-dimensional laser sensor being configured for collecting data relating to a three-dimensional spatial configuration of a workplace where said goods arc stored, said three-dimensional laser sensor being actuatable in rotation by an actuating member around a first rotation axis and, at a same time, around a second rotation axis orthogonal to said first rotation axis;
an internal control unit arranged within said frame, said internal control unit comprising a storage memory, said internal control unit being configured to compare said data collected by said at least one three-dimensional laser sensor with a three-dimensional map of said workplace stored in said storage memory in order to detect an absolute position of said vehicle, and said internal control unit being further configured to send a control signal to said actuating means for directing said vehicle according to a predetermined route;
a wireless data transmission system comprising a data transmission board installed on said vehicle; and
a central control unit external to said at least one automated guided vehicle, said central control unit being configured to receive data from said internal control unit of said at least one automated guided vehicle via said wireless transmission system, said data relating to said absolute position of said at least one automated guided vehicle and said central control unit being configured to ensure said vehicle follows said predetermined route to reach an operating station for picking and/or depositing said goods.

11. A method according to claim 1, further comprising a further step between the step of sending said control signal to said actuating means and carrying out depositing and/or picking of said goods or said support means on which said goods arc distributed at said operating station, the further step comprising:
collecting data relating to a size, shape and position of said goods or said support means for pallets via said at least one three-dimensional laser sensor to carry out optimal depositing and/or picking operations.

12. A method according to claim 2, wherein said step of calibrating said automated guided vehicle comprises the steps of:
moving said automated guided vehicle within said workplace to explore said workplace via said at least one three-dimensional laser sensor;
collecting data relating to said three-dimensional spatial configuration of said workplace via said at least one three-dimensional laser sensor;
processing said data by an internal control unit of said automated guided vehicle and obtaining said global three-dimensional map of said workplace via a calculation program executed by a processor of said internal control unit.

13. A method according to claim 4, further comprising the step of:
repeating calibrating said automated guided vehicle to obtain said global three-dimensional map of said workplace where said goods are stored in order to obtain an updated or new three-dimensional map of said workplace, if said workplace is to be modified or use a new workplace for storing said goods.
